(19) United States
(12) Patent Application Publication
(10) Pub. No.: US 2008/0079592 A1
(43) Pub. Date: Apr. 3, 2008

(54) Battery voltage monitor

(76) Inventor: Gary R. Latinis, Pottsboro, TX (US)

Correspondence Address: John E. Vandigriff, 906 Stone Circle Ln, Lewisville, TX, 75056, US

(21) Appl. No.: 11/975,650

(22) Filed: Oct. 22, 2007

Related U.S. Application Data
(63) Continuation-in-part of application No. 10/929,462, filed on Aug. 31, 2004, now abandoned.

(51) Int. Cl. G08B 21/00; G08B 3/10; H04Q 5/22

(52) U.S. Cl. 340/636.15; 340/10.1; 340/384.4

(57) ABSTRACT

A battery monitor called a “Voltminder” connects to one or more batteries requiring monitoring via a cigarette lighter cord, or by direct connection to the battery circuit. The battery may be mounted in a motor vehicle, boat, recreation vehicle, or any place requiring the monitoring of the battery voltage. A UHF transceiver transmits the battery voltage, interior temperature, and transmitter ID on a periodic basis to a remote receiver. The transmitter transmits the identity of the particular battery so the distinct battery is know, to distinguish it from other monitored batteries.

### FIELD OF THE INVENTION

The invention relates to a voltage monitor, and specifically to a device for monitoring a battery from a location near the battery by a direct connection, or by monitoring the battery from a remote location using transmitting and receiving devices.

### BACKGROUND OF THE INVENTION

A review of the prior art disclose patents related to battery monitoring. The background of the invention is shown in the following patents. These patents are distinct from the invention and are described to show the prior art and the distinctness of the invention from this prior art.

U.S. Pat. No. 6,242,157 A system and method for monitoring and reporting on the condition of a vehicle battery which measures battery voltage and current drain during engine start, and computes the battery dynamic internal resistance (IR) and dynamic polarization resistance (PR) from these quantities. Also, the quiescent voltage (QV) of the battery, which is that measured while the vehicle electrical system has a current drain of from 0 to a predetermined amount, is measured and the battery state-of-charge (SoC) is computed from the QV. From these quantities, calculations are made of quantities such as rate of change of dynamic IR and PR to analyze battery condition, rate of change of QV and SoC to predict the time during which the battery can still start the engine, and minimum ambient temperature at which the battery will be able to start the engine, and of other conditions. Appropriate messages can be displayed of the measured and computed quantities as well as warnings to advise the driver of various real and potential problems related to the battery, its cables and components of its charging system.

U.S. Pat. No. 5,900,724 A low battery voltage detection and warning system connected to sense a voltage charge of a power source within a vehicle such as the vehicle battery. The low battery voltage detection and warning system includes a voltage sensor connected to the power source for sensing a voltage value of the power source and a processing device connected to the voltage sensor for comparing the sensed voltage value to a reference value and determining if the sensed voltage value is less than the reference value. An alarm is connected to the processing device for generating an alarm upon a determination by the processing device that the sensed voltage value is less than the reference value. The alarm may produce at least one of an audible and visual alarm to alert the operator of the vehicle that the battery voltage is low and should be checked. The determination that the battery voltage is low indicates that the vehicle will only start a few more times before the battery is charged to a value too small to start the vehicle.

U.S. Pat. No. 4,320,334 Apparatus for providing a continuous indication of battery state-of-charge under load in a system in which the battery is subject to varying load conditions. The apparatus stores a value representative of battery open circuit terminal voltage and reduces the stored value while the battery is loaded at a rate proportional to the difference between the stored value and a scaled value of actual battery terminal voltage. If the scaled value exceeds the stored value, the stored value is increased to a value corresponding to the scaled value.

U.S. Pat. No. 6,373,256 A low battery detect circuit with digitally programmable detect levels. The programmable low battery detect circuit includes a comparator that compares a stable reference voltage against a battery-supplied voltage as divided down by a digitally programmable resistive divider chain. By programably varying the resistance of the divider chain, the low battery detect threshold level can be varied depending on the requirements of the application.

### SUMMARY OF THE INVENTION

The invention, called a “Voltminder” connects to one or more the batteries requiring monitoring via a cigarette lighter cord, or by direct connection to the battery circuit. The battery may be mounted in a motor vehicle, boat, recreation vehicle, or any place requiring the monitoring of battery voltage. A UHF transceiver transmits the battery voltage, interior temperature, and transmitter ID on a periodic basis.

Each Voltminder consists of seven subsystems: power filtering/regulation, microcontroller, LCD display, real-time clock, input switches, audible alert, and a UHF transceiver. The microcontroller samples the vehicle power and displays it on the LCD while periodically transmitting the value over the UHF radio link. Also transmitted are the alarm status, temperature and a transmitter ID. A menu oriented display system enables the setting of the alarm set-point, transmitter ID, clock setting, and display preferences. All Voltminder units are electrically identical and are configured by the setup menu as a transmitter or a receiver. The number of transmitters is limited to 128. An unlimited number of receivers are possible.

The transmitter will transmit the voltage, temperature, alert status, and ID at a random interval between 3 and 5 minutes. Prior to transmitting, the unit will listen using the receiver to detect another unit transmitting. If a transmitter is not detected, the unit will transmit the data packet four times, this ensures that at least one data packet will be received. If the receiver detects a transmitting Voltminder, it will wait 10 seconds and then attempt another transmission, this will continue until the channel is clear and a transmission can take place.

A battery is connected to voltage monitor which has a user set alarm system. When the voltage of the battery stays below a user set value for one minute, the device will activate a warning light and buzzer. If the device is in a quite mode, it will display a “Low battery” message on a display screen. A similar warning will be issued if the rate of voltage change passes a set, predetermined value. The device is designed for situations where the battery powers a starter for a internal combustion motor, or where an alternator charges the battery from a running engine, for example, a boat or truck. The constant value detection warns of a battery unable to start a motor on the next start up attempt due to lack of charge, or large internal resistance. If the voltage of a battery drops quickly while the engine is running, it is likely there is a problem with the alternator, and the device warns of such a situation in a manner according to the current mode. A temperature sensor in the engine compartment may be included to adjust the steady voltage limit in accordance with the temperature to which the battery is exposed.

The VoltMinder performs two very critical functions: Alerts the operator that the battery is approaching a voltage that will not be sufficient for the engine to start; and Alerts the operator that the battery is not charging while the engine is in operation 1Transmitter will check radio channel before transmitting. The addition of a receiver allows the Voltminder to check the radio channel for a busy state. If busy, the transmitter waits until the channel is clear before transmitting. This reduces the chances of two transmitters transmitting at the same time, thus improving the reliability of the data transmission in a multiple Voltminder system.

The Multi-line display can display the status of 4 volt minders simultaneously. The multi-line display can display the voltage, temperature, link status, alert status and data reception time for up to 4 Voltminders. The user can select which of the 4 Voltminders is displayed on the main (large display).

The display will show 4 Voltminder data line while in the main screen. It will monitor up to at least 64 Voltminders in the background. If a background monitored Voltminder gives a alarm status, the display will add this line to the displayed Voltminders. If the number exceeds 4, the screen will flip from data screen 1 to 4 for 20 seconds, then data screen 5 to 8 for 20 seconds, for up to 16 screens.

Each line on the multilane display will display the link status. This will inform the user if the receiver is receiving the signal from the transmitting Voltminder. If the link status is bad, the user should disregard the data from this Voltminder.

If any linked Voltminder is in an alarm condition, the receiver will give a visual and audible warning. The warnings can be turned off on an individual basis while the alert status is indicated on the display. Warning from other Voltminders will be given visually and audibly if they are not disabled.

Any Voltminder can act as a vehicle mounted transmitter, and any Voltminder can act as a receiver. The Voltminder is setup as a transmitter or receiver in its setup mode. This mode selection is maintained until changed by the user.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 shows the voltage monitor;

FIG. 2 is a block diagram of the battery voltage monitor; and

FIGS. 3a and 3b is a circuit diagram of a receiver device used in conjunction with the battery voltage monitor.

### DESCRIPTION OF A PREFERRED EMBODIMENT

Operation

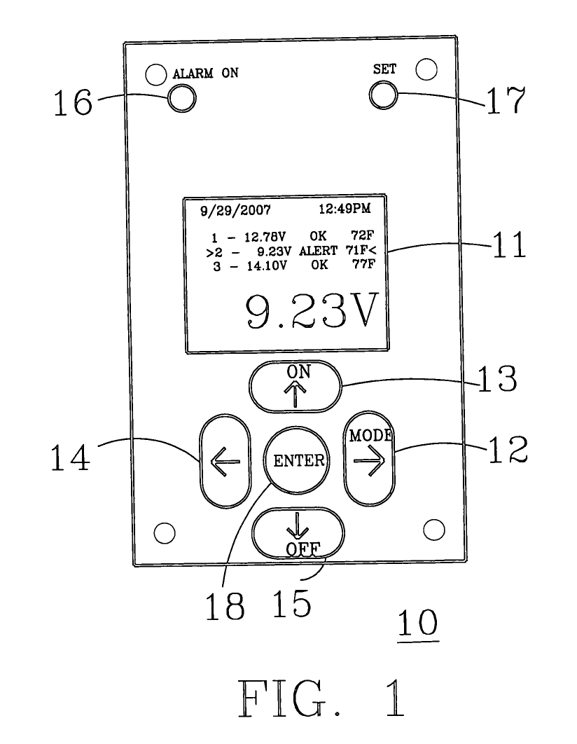

The inventions current embodiment consists of a front mounted LCD display 11 (See FIG. 1) for displaying the real time battery voltage and the battery alarm set-point during setup mode. This display will also display LOW BATT when the battery voltage drops below the set-point. Additionally the LCD display can also show the vehicle ID followed by the battery voltage for that vehicle in a multi-vehicle system or the vehicles temperature. The current time is always displayed, except in SETUP mode. If a programmed vehicle is not being received, a warning is displayed on the LCD display. Up to 8 vehicles can be monitored on each Voltminder. Status of each vehicle can be displayed in a list format on the LCD. Also on the front panel are a Red LED, Green LED, and five switches. The Green LED 16 displays the status of the Alarm sounder (Green LED illuminated for sounder enabled). When the Green LED is illuminated and any battery voltage drops below the user defined and stored set-point for one minute, the internal Piezoelectric sounder will beep on and off at a fast rate. The Red LED 17 serves two functions, during setup mode, it indicates that the device is in setup mode, and secondly the LED will flash when the battery voltage drops below the set-point for one minute.

The five front mounted switches; UP 13, DOWN 15, LEFT 14, RIGHT 12 and ENTER 18 operate as follows:

Pressing the UP or DOWN switch will scroll up or down through the menu categories.

Pressing ENTER will execute the command.

These categories are: BATTERY, and SETUP

SETUP mode: (Transmitter or Receiver)

Left/Right selects: Set Battery Set-point, set vehicle ID, Set Time, Set Mode.

With SETUP selected, pressing the ENTER button will to enter Setup mode. Setup mode is indicated by the Red LED being illuminated. During Setup mode, the LCD will display the Set-point voltage (if the battery voltage drops below this value, the alarm will sound) and vehicle ID. This set-point and ID are stored in non-volatile Flash memory. During Setup mode, each closure of the UP and DOWN buttons will raise or lower the set-point by one count. When the set-point exceeds 13.00 it will roll over to 10.50 and if the set-point goes below 10.5 it will roll over to 13.00. Each closure of the LEFT or RIGHT Switch will move from Battery set-point, to vehicle ID, to time set, to mode select, to Battery Set-point, etc.

If vehicle ID is selected, the UP or DOWN switch will increase of lower the Vehicle ID from 1 to 8.

Setting the time is done in a similar manner, LEFT or RIGHT selects hours or minutes, UP or DOWN increments or decrements the hour or minute. A Flashing inverted cursor indicates the value being changed.

Setting the mode will set the unit as a vehicle mounted (transmitter) or display unit (receiver). If selected as vehicle mounted, the unit will transmit the voltage, temperature, and alarm condition periodically.

The Setup mode is exited by pressing the ENTER button again, the Red LED will extinguish, the value stored in Flash Memory, and the LCD display will display the real-time battery voltage.

BATTERY Mode: (Transmitter)

While in normal monitoring Mode, the UP button will enable the sounder if pressed once, the Green LED will illuminate. Pressing the UP button again will extinguish the Green LED and disable the sounder. In both modes the LOW BATT symbol will illuminate and the alert signal will transmit if the battery voltage drops below the set-point.

If the UP button is pressed while the alarm has been activated (battery voltage below set-point) the beeping alarm is cancelled and only the LOW BATT is displayed. If the battery voltage rises above the set-point value at any time, the alarm will turn off and the voltage will again have to drop below the set-point for one minute.

BATTERY Mode: (Receiver)

While in normal monitoring Mode, the UP button will enable the sounder if pressed once, the Green LED will illuminate. Pressing the UP button again will extinguish the Green LED and disable the sounder. In both modes the LOW BATT symbol will illuminate, and the Voltminder ID is displayed if the received alert status indicates the transmitting Voltminder's battery has dropped below the setpoint for at least one minute.

If the UP button is pressed while the alarm has been activated (received battery voltage below set-point) the beeping alarm is cancelled and only the LOW BATT is displayed. If the transmitted alert status turns off at any time the LOW BATT and alarm will stop.

The normal display will display the following: Transmitter ID, Voltage, temperature. Each transmitter's data is displayed on a single line, 4 lines total. Every 15 seconds the first 4 transmitter ID lines are replaced by the second 4 transmitter ID's. This only occurs if more than 4 transmitters are in range. If a transmitter is mated to the receiver, it is expected to be received within 10 minutes. If a mated transmitter's signal is not received after 10 minutes the line associated with this transmitter will flash and the word “ERROR” will appear at the end of the line.

Using the UP/DOWN arrows to select the line with the transmitter of interest, followed by pressing the ENTER button will display this Voltage, temperature and ID in large characters on the display. These characters are twice the size of the multi-line display.

The current time is displayed at all times.

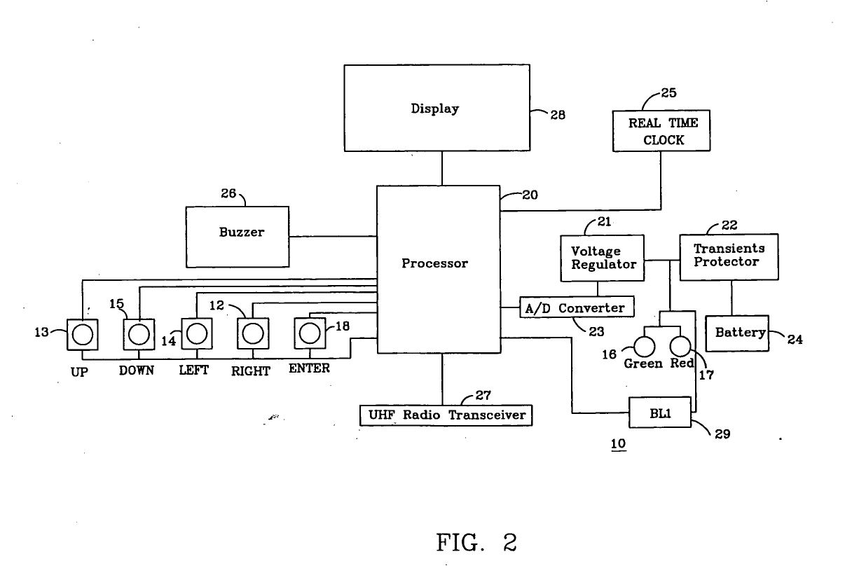

FIG. 2 is a block diagram of the battery voltage monitor 10. It consist basically of a processor 20 that controls and allows programming of the voltage monitor. A front mounted LCD display 28 displays the real time battery voltage and battery alarm set point during setup mode. Display 28 will also display LOW BATT when the battery voltage drops below the set point. Display 28 also shows the battery ID followed by the battery voltage for that battery in a multi-battery system. On a front panel of the voltage monitor are Red LED (17) and Green (16) LEDs, and five push button switches, 12, 13, 14, 15 and 18. The Green LED 16 displays the status of the Alarm sounder (Green LED illuminated for sounder enabled). When Green LED 16 is illuminated, and the battery voltage drops below the user defined and stored set point for one minute, Piezo sounder 26 will beep on and off at a fast rate. Red LED 17 serves two functions during setup mode. It indicates that the monitor is in setup mode, and secondly the LED 17 will flash when the battery voltage drops below the set point for one minute.

While in normal monitoring Mode, the UP button 13 will enable the sounder 26 if pressed once, the Green LED 16 will illuminate. Pressing the UP button 13 again will extinguish the Green LED 16 and disable the sounder 26. In both modes, the LOW BATT symbol will illuminate on display 28 if the battery voltage drops below the set point.

If the UP button 13 is pressed while the alarm has been activated (battery voltage below set point) the beeping alarm is cancelled and only the LOW BATT is displayed. If the battery voltage rises above the set point value at any time, the alarm will turn off and the voltage will again have to drop below the set point for one minute.

As shown in FIG. 2, the voltage monitor connects to battery 24 though a transient protector 22 and a voltage regulator 21. The voltage is then converted to a digital value with the A/D converter 23. A UHF radio transceiver 27 is attached for communicating between the monitor and the battery on the vehicle. A backlight 29 may be used in conjunction with display 28

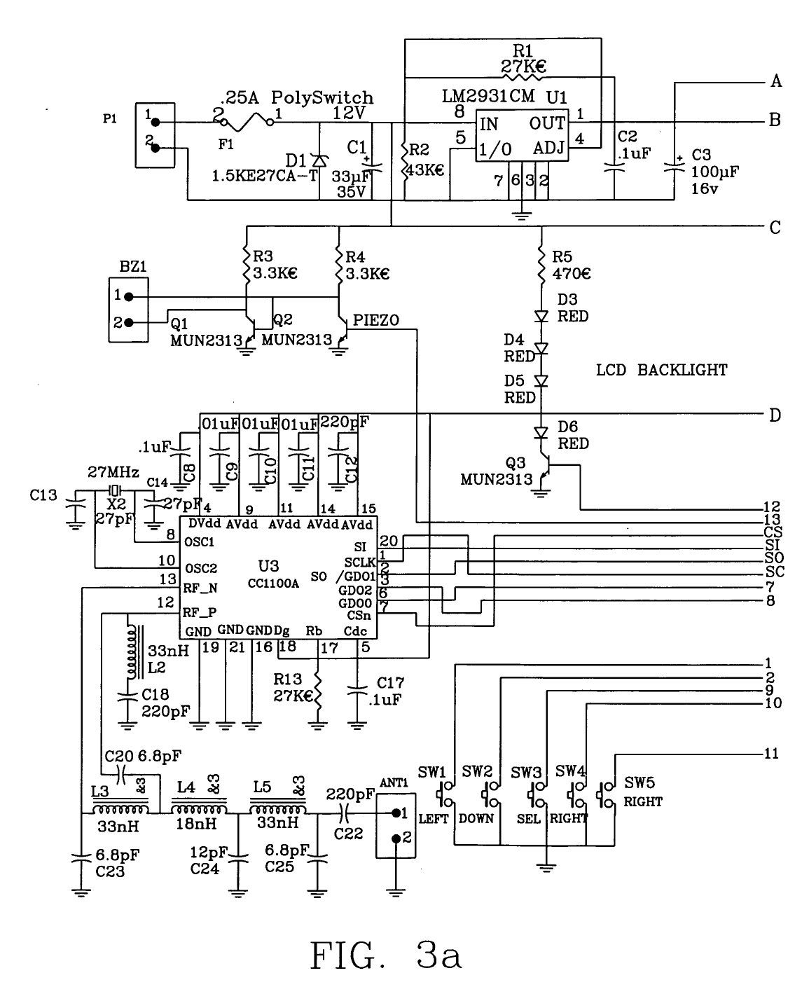

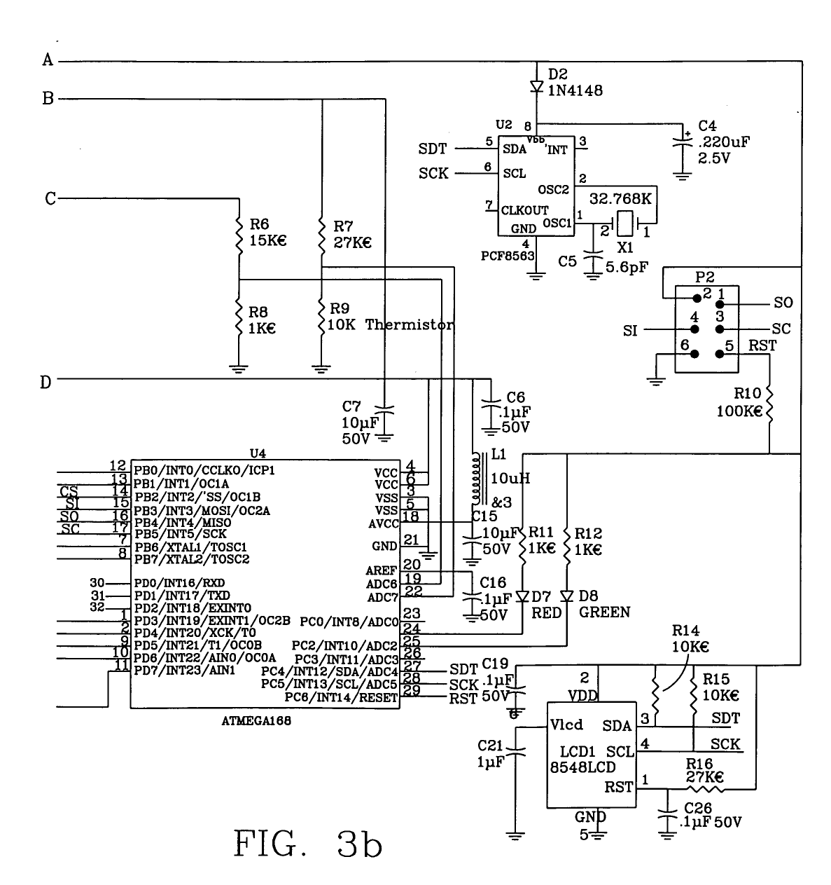

The basic circuit is shown in FIGS. 3a and 3b. The battery being monitored connects to a 3.0 volt voltage regulator U2 that provides a regulated reference voltage for the invention. The battery voltage is also divided by a factor of 16 to scale the voltage to the maximum tolerated by the microprocessor analog to digital converter, 1.1 volts. The invention is protected from positive transients above 27 volts and negative transients above 1 volt by D1. A Successive approximation A/D converter internal to the microcontroller converts the scaled battery voltage to binary value internal to the microprocessor. The LCD displays this binary value as a voltage. This binary value is compared against the Flash memory stored user changeable set-point to determine is the alarm is activated. The microprocessor generates a 2.6 KHz square wave to drive the piezoelectric sounder ON and OFF to warn the user of the low battery condition. LED's and switches are interfaced to the microprocessor in a standard manner.

The microprocessor chosen has an internal 1.1 volt voltage reference for the A/D converter. An I2C serial LCD displays the voltage and other information. Many other displays could be used. U2 is an I2C Real Time Clock; this device maintains a count of the time and date. Communication to the microcontroller takes place via I2C serial data buss.

A single chip UHF transceiver, U3, acts as a UHF radio transmitter and receiver. A LC filter couples the transceiver to the antenna.

Detailed Circuit Description

F1—Resetable polymer fuse provides circuit protection.

D1—Transient absorber provides negative transient and 27 volt transient clamping for circuit protection.

C1—Transient and low frequency noise rejection.

U1—3.0 Volt voltage regulator. (Low dropout, automotive transient survivable).

R2, R1—Voltage divider to set output voltage of U1.

C3—Output filter capacitor for voltage regulator. Maintains regulator stability.

C2—High frequency noise filter.

D2—Isolation diode for Real Time Clock (RTC) power. Prevents discharge of C4 when power is lost.

U2—I2C Real Time Clock circuit. Counts time, date. Communicates via I2C to microcontroller.

X1—32.768 KHz crystal, frequency reference for RTC.

C5—Provide proper capacitive loading for crystal.

C4—Power storage capacitor to provide power (1 minute) to the RTC when power is lost.

R3, R4—Collector load for piezoelectric sounder's amplifier.

Q1,Q2—Push-pull amplifier for piezoelectric sounder. R5—Current limiting resistor for LCD backlight.

D3, D4, D5, D6—LCD backlight illumination LED's

Q3—LCD backlight transistor switch.

R6, R8— 1/16 voltage divider for battery voltage.

R7—Part of the voltage divider shared with the thermistor.

R9—Negative temperature coefficient thermistor. Voltage across thermistor is related to the ambient temperature.

P2—Microcontroller programming connector.

R10—Pullup resistor for Reset line.

C8, C9, C10, C11, C12—Noise decoupling capacitors for transceiver.

C13, C14—Load capacitors for transceiver frequency reference.

X2—27 MHz transceiver frequency reference.

U3—UHF transceiver.

L2, L3—Part of Transceiver matching network.

C18, C23, C20—Part of Transceiver matching network.

L4, L5, C24, C25, C22—433 Mhz LC Band pass filter.

SW1, SW2, SW3, SW4, SW5 User input switches.

C7, C6 Microcontroller decoupling capacitors.

L1, C15—A/D converter power filter.

C16—Voltage reference smoothing capacitor.

R11, R12 Front Panel Red and Green LED current limiting resistor.

D7—RED front panel LED

D8—GREEN front panel LED

U4—8 bit 16 Kbyte Flash AVR microcontroller.

LCD1—I2C serial Graphic LCD display 105×54 dots.

R14, R15—I2C pull-up resistors

R16, C26—RC power up reset delay circuit for LCD

C21—LCD panel voltage filter capacitor

C19—LCD panel decoupling capacitor

Transceiver

The Voltminder will transmit a serial number identifying the transmitter to the receiver via Bi-phase data encoding of 433 MHz RF on-off keying. The ID number, voltage, temperature and alarm status are transmitted. In receive mode the 433 MHz receiver detects the Bi-phase data and presents it to the microprocessor for decoding. ID number, voltage, temperature and alarm status are received.

Calibration

Power is switched off to the Voltminder. The mode and Up buttons are pressed and held down. A precise 12.0 volts is applied to the voltminder. As the program starts, the status of the mode and UP switches if low places the device in calibration mode. The voltage is assumed to be exactly 12.00 volts. The microprocessor will do an A/D conversion and store the result. Based on this result and the 12.00 volt input, a scaling factor is computed. This scaling factor is stored in Flash and used in the Voltminder A/D conversion process. Power is disconnected and the Voltminder returns to normal operation.

What is claimed:

1. A voltage monitor for monitoring at least one battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status of one to four monitors at one time; and
an audible signal generator for producing a sound when a monitored battery falls below a predetermined voltage.

2. The voltage monitor according to claim 1, including a UHF radio transceiver for transmitting/receiving battery information.

3. The voltage monitor according to claim 1, including a voltage regulator connected to the programmable monitor.

4. The voltage monitor according to claim 1, including a plurality of switches for programming the voltage monitor.

5. The voltage monitor according to claims 1 wherein a battery ID number, voltage, temperature and alarm status are transmitted.

6. A voltage monitor for monitoring a battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status;
an audible signal generator for producing a sound when a monitored battery falls below a predetermined voltage; and
a UHF radio transceiver for transmitting/receiving battery information.

7. The voltage monitor according to claim 6, including a voltage regulator connected to the programmable monitor.

8. The voltage monitor according to claim 6, including a plurality of switches for programing the voltage monitor.

9. The voltage monitor according to claim 6, including a flash memory in which the value of the predetermine voltage is stored.

10. The voltage monitor according to claim 6, wherein a battery ID number, voltage, temperature and alarm status are transmitted.

11. A voltage monitor for monitor at least one battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status;
an audible signal generator for producing a sound when a monitored battery falls below a predetermined voltage;
at least one receiver to receive a signal from a voltage monitor, including a ID number, voltage, temperature and alarm status, and a transmitter to transmit a signal when the monitored voltage falls below a predetermined value.

12. The voltage monitor according for claim 11, including circuitry for monitoring a plurality of batteries.

13. The voltage monitor according to claim 1, wherein the voltage monitor can function as either a transmitter and receiver.

14. The voltage monitor according to claim 1, where the voltage monitor will monitor up at least 64 monitors in a background status.
